(19) United States
(12) Patent Application Publication
(10) Pub. No.: US 2023/0301867 A1
(43) Pub. Date: Sep. 28, 2023

(54) PERCUSSIVE MASSAGE DEVICE

(71) Applicant: MerchSource, LLC, Irvine, CA (US)

(72) Inventors: Keith Covey, Costa Mesa, CA (US); Adam Sbeglia, Fullerton, CA (US); David Yang, Santa Ana, CA (US); Rene Hart, New Canaan, CT (US)

(21) Appl. No.: 17/704,780

(22) Filed: Mar. 25, 2022

(51) Int. Cl. A61H 23/00; A61H 23/02

(52) U.S. Cl. CPC A61H 23/006; A61H 23/02; A61H 2201/1463; A61H 2201/0153; A61H 2201/5025

(57) ABSTRACT

A percussive massage device includes a motor including a rotatable shaft, a piston configured to reciprocate rotation of the rotatable shaft, where velocity of the piston is a function of a rotation speed of the rotatable shaft, an amplitude adjustment system having user-selectable settings, where the amplitude adjustment system controls a distance the piston travels, and a speed control system configured to control the rotation speed of the rotatable shaft.

### FIELD OF INVENTION

The present invention relates to a percussive massage device including a piston and an amplitude adjustment system to control a distance a piston travels.

### BACKGROUND

Percussion massage, also referred to as tapotement, is a rhythmic percussive striking of areas of the human body. Percussion massage can include hitting, slapping, tapping, or cupping the areas to “wake up” the nervous system and strengthen deep-tissue muscle. The percussion massage can be applied by devices that include a motor connected to a reciprocating piston that creates the percussion massage treatment. A percussive massage device may include a plurality of user-selectable frequency settings that define how often the applicator strikes the area of the human body. Conventionally, the percussive massage device includes a factory-set distance that the applicator travels that is not adjustable by a user.

### SUMMARY OF INVENTION

The following is a brief summary of subject matter that is described in greater detail herein. This summary is not intended to be limiting as to the scope of the claims.

The present application provides a percussive massage device that includes an amplitude adjustment system permitting a user to select a travel distance of a percussive applicator. More particularly, the amplitude adjustment system includes user-selectable amplitude settings that correspond to different travel distances. The percussive massage device includes a motor and a piston that reciprocates motion of the motor to generate the percussion. The piston travels along a travel path based on the motor motion and the amplitude adjustment system can be used to define the travel path. The percussive applicator is attachable to the piston and by controlling the travel distance of the piston, the amplitude adjustment system controls the travel distance of the percussive applicator. The percussive massage device further includes structure permitting the user to select from the user-selectable amplitude settings. Selectably controlling a percussive applicator's travel distance is advantageous in that the user can select a desired depth of the percussive massage. For instance, the user can select a first amplitude setting for a deep tissue percussive massage while the user can select a second amplitude setting for a short massage depth. In one example, significantly shortening the travel distance the percussion massage device can cause it to function like a vibrating massage device.

The percussive massage device may further include a speed control system configured to control movement of the motor. The motor can include a rotatable shaft and the speed control system can control how fast the rotatable shaft rotates. The percussive massage device may additionally include structure permitting the user to select a desired frequency for the percussion applicator and the speed control system uses this information to select a rotation speed for the rotatable shaft which is reciprocated by movement of the piston. Because the frequency is a function of both speed and distance, changes to the travel path impact the frequency. To that end, the speed control system may be configured to use the selected amplitude setting to set the rotation speed of the motor in order to maintain a selected frequency regardless of the size of the travel path.

The percussive massage device may further include device body that includes a first portion defining a housing that retains at least a portion of the motor, the piston, the amplitude adjustment system, and/or the speed control system. The device body may further include a second portion defining a handle for holding, by the user, while applying the percussive massage.

According to an aspect of the invention, the amplitude adjustment system can comprise a ratchet and pin system. The ratchet and pin system may include a pin that revolves about a revolution axis, a ratchet attached to the pin, and at least one pawl. A radial distance of the pin from the revolution axis is defined by the interaction of the ratchet and the at least one pawl. The radial distance of the pin from the revolution axis controls the distance the pin travels. The amplitude adjustment system can further include an adjustment system that engages and disengages the at least one pawl at the ratchet to permit the user to select different amplitude settings.

According to an aspect of the invention, the amplitude adjustment system can comprise a linkage system including a plurality of interlinked bars. The linkage system can include at least one fixed pivot point in the percussive massage device and at least one linkage movable with respect to the fixed pivot point, wherein the position of the at least one linkage with respect to the pivot point controls the distance the piston travels.

According to an aspect of the invention, a percussive massage device includes a motor including a rotatable shaft a piston configured to reciprocate rotation of the rotatable shaft where velocity of the piston is a function of a rotation speed of the rotatable shaft, an amplitude adjustment system having user-selectable settings where the amplitude adjustment system controls a distance the piston travels, and a speed control system configured to control the rotation speed of the rotatable shaft.

According to an aspect of the invention, an amplitude adjustment system includes a first portion in communication with a motor, where the motor includes a rotatable shaft, and a second portion in communication with a piston of a percussive massage device, where the piston is configured to reciprocate rotation of the rotatable shaft, wherein velocity of the piston is a function of a rotation speed of the rotatable shaft, where the amplitude adjustment system has user-selectable settings that control a distance the piston travels.

The above presents a simplified summary in order to provide a basic understanding of some aspects of the systems and/or methods discussed herein. It is not an extensive overview of the systems and/or methods discussed herein. Nor is it intended to identify key/critical elements or to delineate the scope of such systems and/or methods.

### BRIEF DESCRIPTION OF THE DRAWINGS

FIG. 1 illustrates a block diagram of an exemplary percussive massage device.

FIG. 2 illustrates an exemplary percussive massage device.

FIG. 3 illustrates a cross-sectional view of the exemplary percussive massage device from FIG. 2.

FIG. 4 illustrates an exemplary amplitude adjustment system at a first setting.

FIG. 5 illustrates the amplitude adjustment system of FIG. 4 at a second setting.

FIG. 6 illustrates another exemplary percussive massage device.

FIGS. 7-8 illustrate another exemplary amplitude adjustment system at a first setting.

FIGS. 9-10 illustrate the exemplary amplitude adjustment system of FIGS. 7-8 at a second setting.

FIG. 11 illustrates the exemplary amplitude adjustment system of FIGS. 7-8 employing a second mechanism to adjust the amplitude adjustment system.

FIG. 12 illustrates yet another exemplary percussive massage device.

### DETAILED DESCRIPTION

Aspects of the present application pertain to a percussive massage device are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Disclosed is a percussive massage device that includes a system permitting a user to select an applicator travel distance (i.e., amplitude). The disclosed system permits the user to define a travel path of a piston that reciprocates motor motion to generate the percussion. By defining the travel path of the piston, the user can select how deep the percussive massage can be applied. For example, a larger amplitude setting can result in a deeper tissue massage.

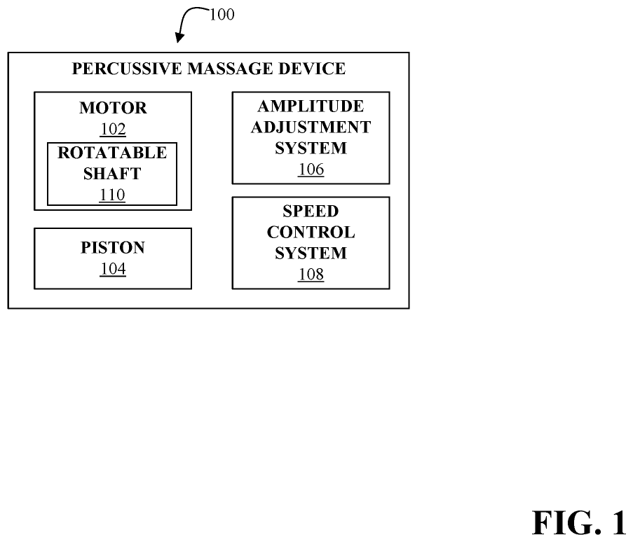

Turning to FIG. 1, illustrated is a percussive massage device 100 that includes a motor 102, a piston 104 configured to reciprocate movement of the motor 102, an amplitude adjustment system 106 configured to control a distance the piston 104 travels, and/or a speed control system 108 configured to control movement of the motor 102. Broadly, in response to movement of the motor 102, the piston 104 follows a travel path and the amplitude adjustment system 106 includes a plurality of user-selectable settings to allow a user of the percussive massage device 100 to select different amplitudes for the piston 104.

In one embodiment, illustrated in FIG. 1, the motor 102 comprises an electric motor that includes a rotatable shaft 110 that rotates in response to electrical energy. In one version, the motor 102 may be powered by direct current (DC) sources, such as electrical batteries or rectifiers. The electrical battery may be rechargeable and/or may be single-use or disposable. In another version, the motor 102 may be powered by alternating current (AC) sources, such as a power grid, inverters, or electrical generators. In yet another version, the motor 102 is configured to use a variety of power sources. For instance, in one scenario the motor 102 can be connected to an AC source while a rechargeable battery in the percussive massage device 100 also charged by the AC source. In another scenario, the motor 102 is disconnected from the AC source and uses the rechargeable battery to power the motor 102.

In addition, the motor 102 may be brushed or brushless, may of various phases (such as single-phase, two-phase, etc.), and may be cooled by any suitable manner (e.g., air-cooled and/or liquid-cooled).

The piston 104 is configured to move along the travel path reciprocating the movement of the motor 102, e.g., the rotation the rotatable shaft 102. In one embodiment, the piston 104 can be configured to travel along a travel path in response to rotation of the rotatable shaft 110. The piston 104 can move linearly along an axis and/or the path can be curved or include multiple angles, as desired. As will be described in detail below, the length of this path can be adjusted using the amplitude adjustment system 106. Additionally, or alternatively, the piston 104 can be configured to rotate in response to rotation of the rotatable shaft 110.

Because the piston 104 reciprocates the movement of the motor 102, the movement of the piston 104 changes when the movement of the motor 102 changes. For instance, a velocity of the piston 104 along the travel path is dependent on the rotation speed of the rotatable member 110. An increase in the rotations per minute of the rotatable shaft 110 causes a corresponding increase in the velocity of the piston 104, and vice versa.

The speed control system 108 is configured to control the speed of the motor (e.g., the rotation speed of the rotatable member 110) and, by extension, the velocity of the piston 104. As will be described in detail below, a user can employ the speed control system 108 to select how frequently the piston 104 moves along the travel path.

As mentioned above, the amplitude adjustment system 106 controls the distance the piston 104 travels. More particularly, the amplitude adjustment system 106 can define a length of the travel path. The amplitude adjustment system 106 can be configured to permit a user to select electronically and/or mechanically from the user-selectable amplitude settings, as will be described in detail below.

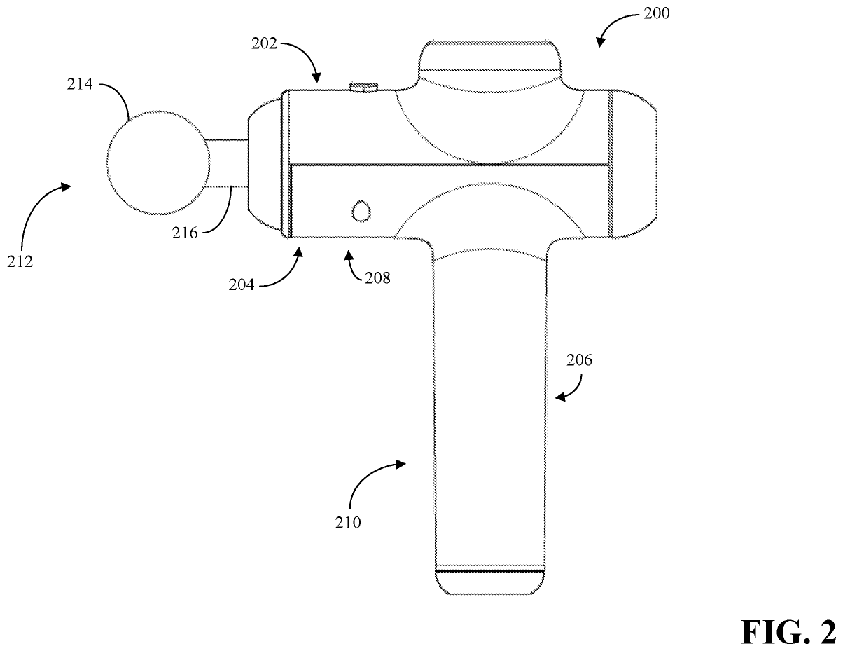

Turning now to FIG. 2, illustrated is an embodiment of a percussive massage device 200. The percussive massage device 200 includes a device body 202 configured to retain at least one of a portion of the motor 102, the piston 104, the amplitude adjustment system 106, and/or the speed control system 108. In the illustrated embodiment, the device body 202 includes a first portion 204 and a second portion 206 extending from the first portion 204. The first portion 204 can form a housing 208 that retains an applicator (described below) for applying percussion generated by the movement of the piston 104. The second portion 206 is shaped to form a handle 210 for holding the percussive massage device 200. The particular shape of the massage device 200 and locations of components therein may be modified without departing from the spirit and scope of the present invention. For example, the device body 202 could be configured such that it forms just a housing for retaining the applicator, and the housing is attached to a stand to hold the percussive massage device 200.

The applicator may be any suitable type, for example, a first size spherical ball, a second larger size spherical ball, a paddle, a prong, a cone, hammer-like head, and/or the like. As shown in FIG. 2, the applicator is spherical. The applicator 212 includes an applicator head 214 and a shaft 216 extending therefrom. The shaft 216 is shaped to be retained within a corresponding indentation in the piston of percussive massage device 200. The shaft 216 can be held in the piston via any suitable means, such as magnets, a twist and lock structure, spring loaded pegs, and/or the like.

In FIG. 2, the handle 210 extends perpendicularly from the housing 208; however, the handle 210 can extend at any suitable angle from the housing 208 (e.g., less than 90°). In the illustrated embodiment, the handle 210 comprises a cylindrical portion extending from the housing 208, however, the handle 210 can comprise multiple components arranged in any suitable arrangement with respect to the housing 208. For instance, the handle may comprise multiple connected components that form a U-shaped handle extending from a side of the housing 208. In another example, the percussive massage device 200 can include multiple handles arranged on opposing sides of the housing 208. As noted above, the particular shape and arrangement of housing and handle, and location of various components therein may be modified without departing from the scope of the invention. In the illustrated embodiment, the housing 208 and the handle 210 are molded together and integral with one another. In another embodiment, the housing 208 and the handle 210 may be manufactured separately and then attached to one another, and may have different shapes and designs.

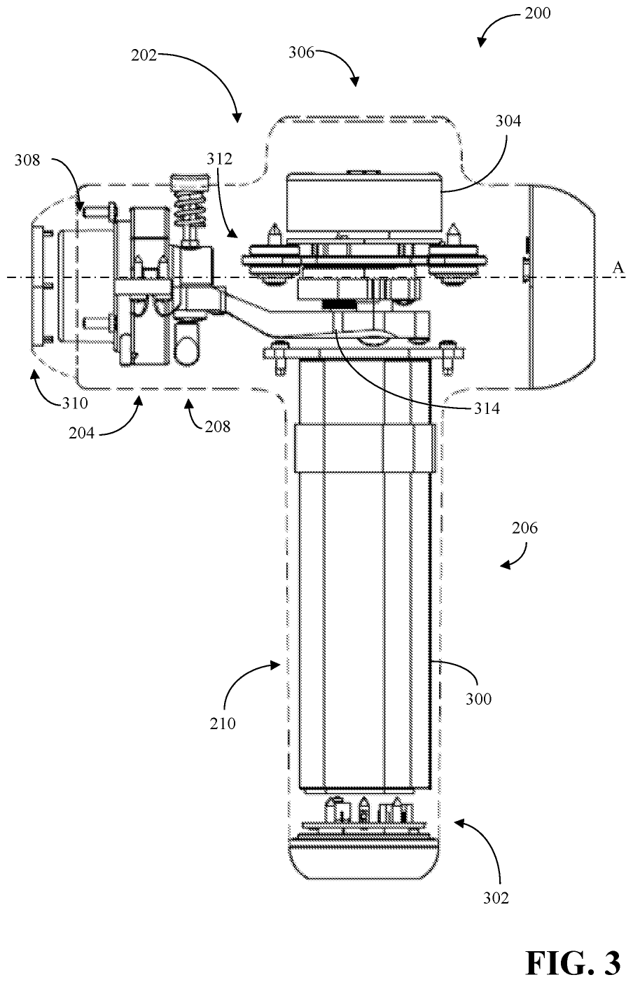

Turning next to FIG. 3, illustrated is a cross-sectional view of the percussive massage device 200. The handle 210 includes a hollow portion for retaining a battery 300, although the battery could also be located elsewhere within the housing 202. In the illustrated embodiment, the battery 300 comprises a rechargeable battery and the percussive massage device 200 includes further structure 302 for connecting the battery 300 to a power source to charge the battery 300.

The battery 300 is in communication with a motor 304 to provide power thereto. In the illustrated embodiment, the motor 304 is retained in an upper portion 204; but may be retained at any suitable location within the device 202, such as in the lower portion 206 or between the housing 208 and the handle 210 or adjacent a side of the housing 208. The housing 208 may further include an airflow portion 306 to permit outside airflow into the housing 208. For example, the airflow portion 306 may include plurality of heat vents formed to prevent overheating of the battery 300, motor 304, and/or corresponding electronics, such as a printed circuit board, during operation.

The motor 304 drives movement of a piston 308 that is movably retained at an end 310 of the housing 208. As noted above, the piston 308 reciprocates movement of the motor 304 (e.g., rotation of the rotatable shaft 110) and follows a travel path. In the illustrated embodiment, the piston 308 and the housing 208 are configured such that the travel path of the piston 308 extends linearly along a reciprocation axis A.

As noted above, the percussive massage device 200 further includes an amplitude adjustment system 312 that defines a length of the travel path of the piston 308. The amplitude adjustment system 312 can be connected to the motor 304 and/or the piston 308. In the illustrated embodiment, the amplitude adjustment system 312 is attached to the motor 304 and a bar 314 connects the amplitude adjustment system 312 to the piston 308.

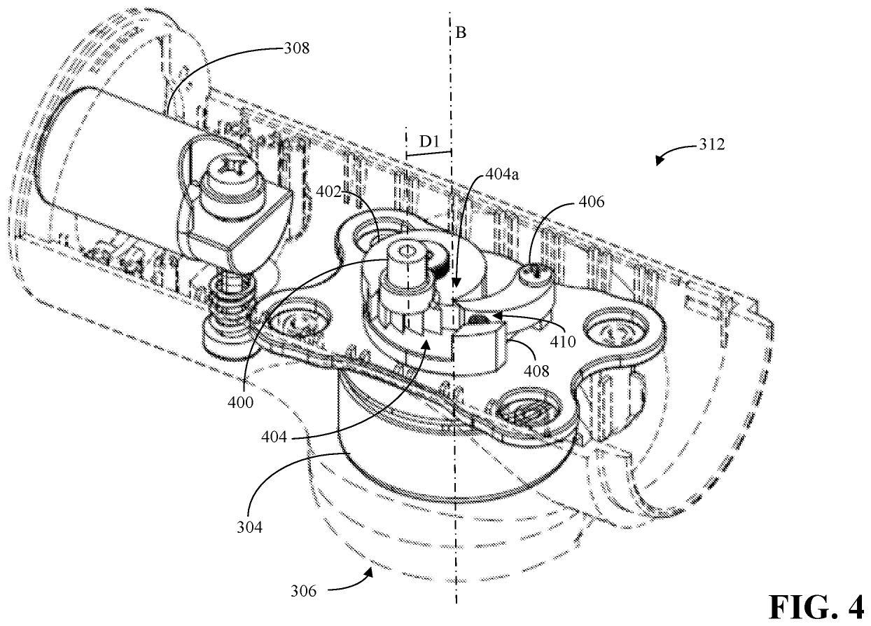

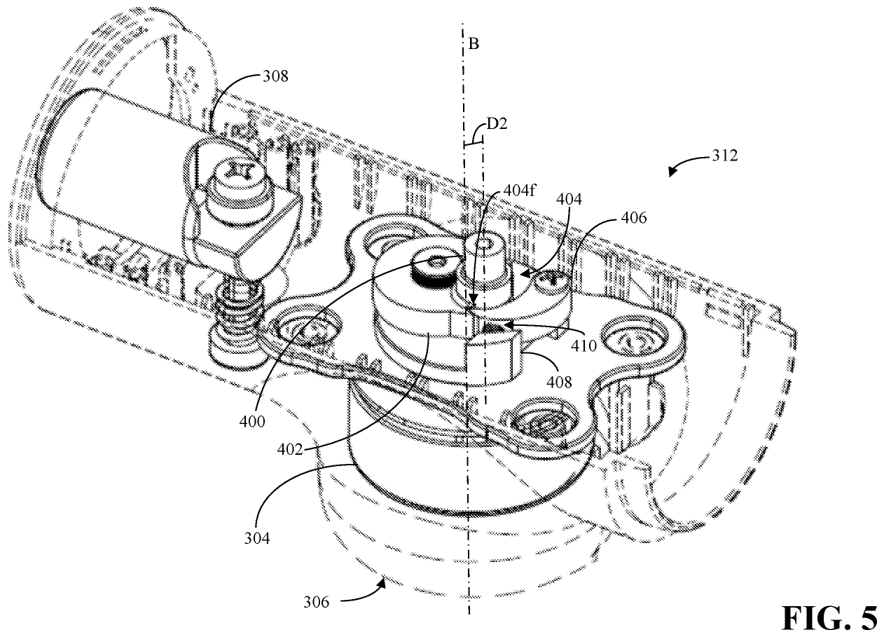

Turning now to FIGS. 4 and 5, illustrated is an interior view of the housing 208 with a portion removed to expose an interior of the housing 208. More particularly, FIGS. 4 and 5 illustrate a view of the amplitude adjustment system 312 at different user-selectable settings. To make it easier to see the different settings, in the following figures, the bar 314 connecting the amplitude adjustment system 312 to the piston 304 is omitted. In the following figures the amplitude adjustment system 312 comprises a ratchet and pin system.

Turning now to FIG. 4, the ratchet and pin system includes a pin 400 configured to revolve about a revolution axis B. The pin 400 extends from a ratchet 402. The ratchet 402 and pin 400 can be formed together and/or formed separately and subsequently attached together. The ratchet 402 is configured to adjust a radial distance of the pin 400 from the revolution axis B. The distance the pin 400 travels is a function of that radial distance and the size of the travel path of the piston 308 is a function of the distance the pin 400 travels. Accordingly, by adjusting the radial distance of the pin 400 from revolution axis B, a user can adjust the distance of the travel path of the piston 308.

The ratchet 402 includes a plurality of notches 404 that correspond to a plurality of radial distances and the ratchet and pin system includes a pawl 406 to engage a notch 404. The ratchet 402 can include any suitable number of notches 404 in any suitable arrangement on the ratchet 402. In the illustrated embodiment, the ratchet 402 includes six notches 404 that are arranged adjacently on a side of the ratchet 402. In another embodiment, the notches can be spaced apart at different quadrants of the ratchet 402.

In the illustrated embodiment, the ratchet and pin system include a single pawl 406; however, it is conceivable that multiple pawls may be employed. The notch 404 and the pawl 406 are shaped to form a locking engagement to maintain a user-selected radial distance during rotation of the motor 304. More particularly, the illustrated pawl 406 comprises a curved shape ending in a point that engages a corresponding section in the notch 404.

The ratchet and pin system further includes structure to latch and unlatch the pawl 406 from the notch 404 in the ratchet 402. In the illustrated embodiment, the structure consists of a peg 408 and a spring 410. The spring 410 can be pre-compressed such that when the spring 410 is attached to the peg 408 at one end and the pawl 406 at the other end, the expansion of the spring 410 drives the pawl 406 into the notch 404. The spring 410 can be further compressed to remove the pawl 406 from the notch 404. The ratchet 402 can then be moved and the spring 410 released so that the pawl 406 engages a second notch 404.

In another embodiment, the spring 410 provides a constant engagement between the pawl 406 and the ratchet 402. In order to adjust the setting of the pawl 406, the pin 400 on the ratchet 402 is fixed (such as via a piston locking mechanism) and the motor 304 is rotated. Because the pin 400 is fixed in place, rotation of the motor 304 causes the pawl 406 to click through the different notches 404 until a particular notch 404 is selected.

FIG. 4 shows an embodiment configured such that the pawl 406 engages a first notch 404a resulting in a radial distance D1 from the revolution axis B. FIG. 5 shows the same embodiment configured such that the pawl 406 engages a sixth notch 404f resulting in a radial distance D2 from the revolution axis B. The radial distance D1 is larger than radial distance D2 which results in a larger travel path for the piston 308.

The percussive massage device 200 may further includes structure that permits the user to adjust the amplitude setting, e.g., which notch 404 the pawl 406 engages. For instance, the percussive massage device 200 may include a dial on the side of the device body 202 that can be used to rotate the ratchet 402 so the pawl 406 engages different notches 404. In another example, the percussive massage device 200 further includes a button that disengages the pawl 406 from a notch 404 and the user rotates the ratchet 402 (e.g., via a dial) and releases the button to allow the pawl 406 to engage a selected notch 404. In yet another example, the percussive massage device 200 may include a user interface that comprises a touch screen or a button(s) that a user employs to electronically select an amplitude setting. In this example, the percussive massage device 200 may include a solenoid to lock a percussion mechanism (e.g., the piston 308) in place and work with the motor 304 to cause the amplitude adjustment system 312 to cycle through the amplitude settings.

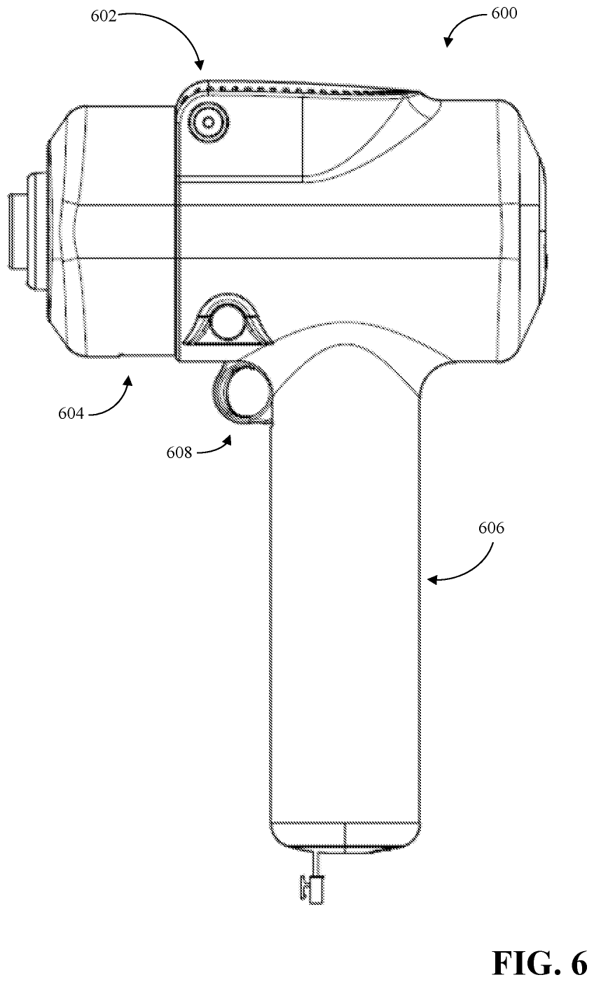

Turning now to FIG. 6, illustrated is another embodiment of a percussive massage device 600. Similar to the percussive massage device 200 in FIG. 2, the percussive massage device 600 comprises a body 602 that includes a first portion 604 and a second portion 606. Percussive massage device 600 further includes a trigger 608 used to adjust the amplitude adjustment system of the percussive massage device 600, as will be described in detail below.

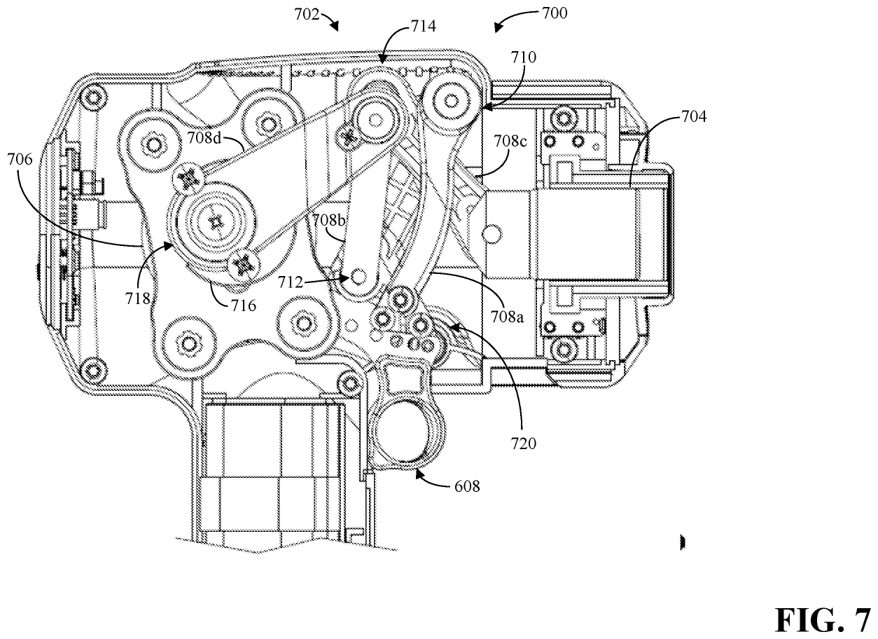

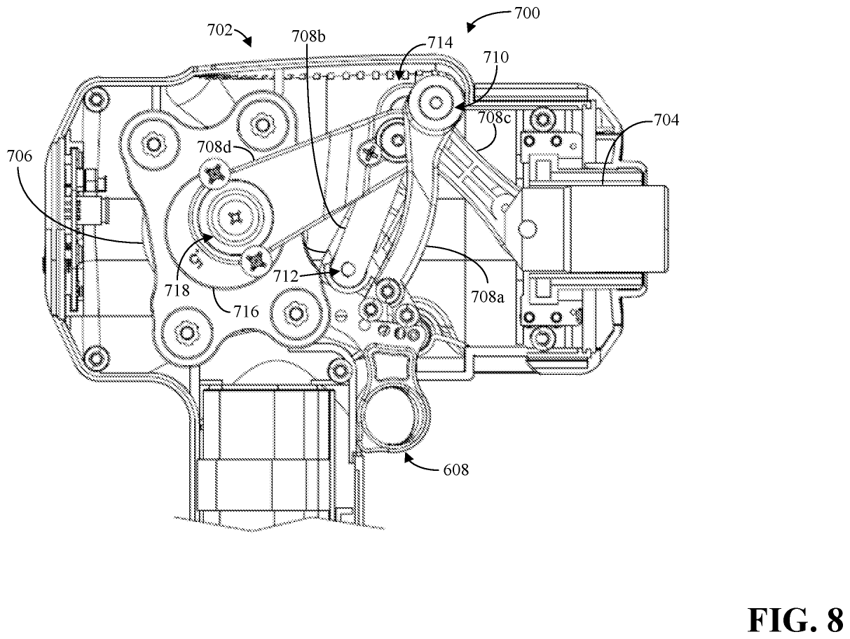

Turning now to FIGS. 7-10, illustrated is an amplitude adjustment system 700 of the percussive massage device 600. Discussion will now be made with reference to FIG. 7 but can be applied to the FIGS. 8-10. The amplitude adjustment system 700 comprises a linkage system 702. The linkage system 702 includes a plurality of moving bars interlinked to define a travel path of the piston 704. The illustrated linkage system 702 is connected to a motor 706 and the piston 704 to also translate motion of the motor 706 for reciprocation by the piston 704.

The linkage system 702 is configured to rotate with respect to a pivot point within the percussive massage device 700 while translating the motion the motor 706. A position of a linkage with respect to the pivot point can define a movement path of the linkage system 702 and, by extension, the travel path of the piston 704.

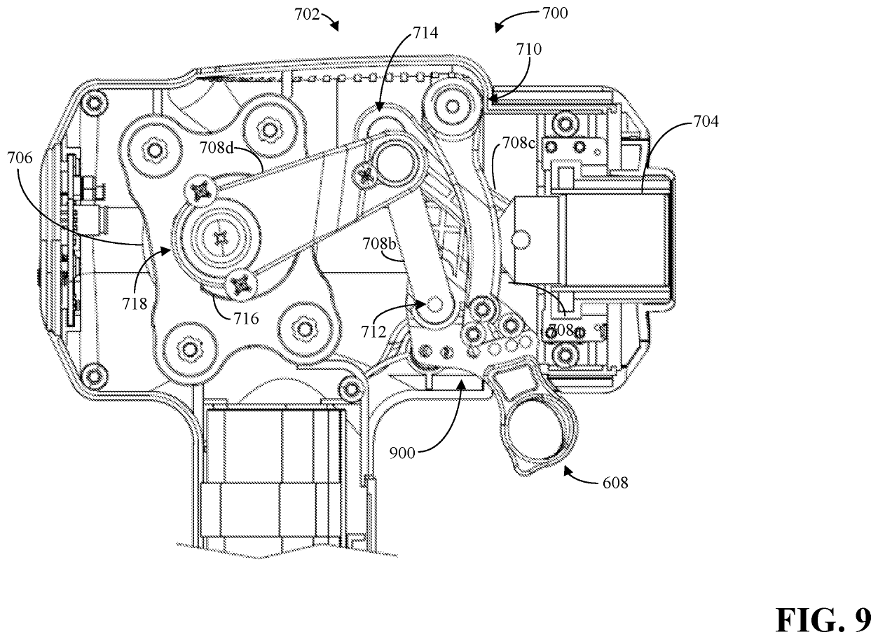

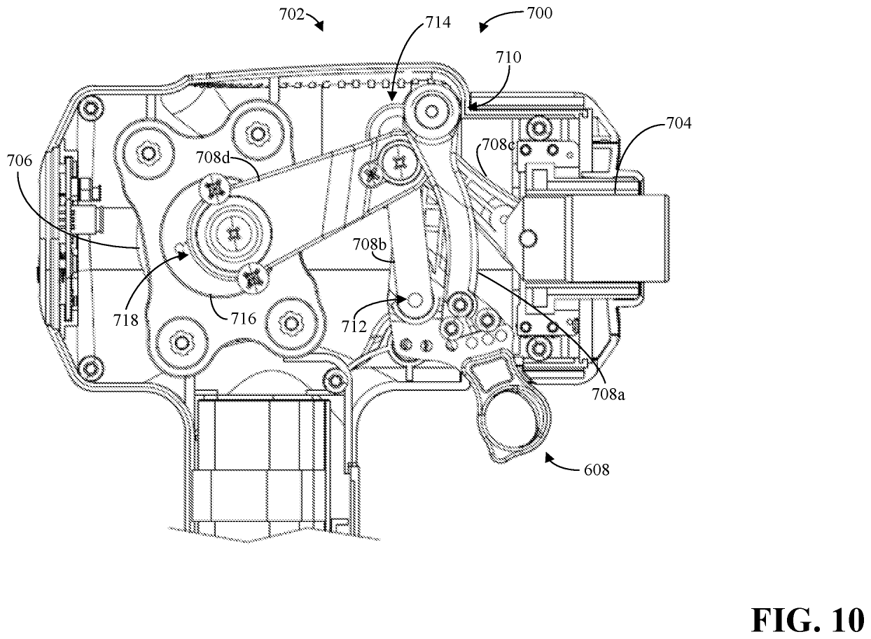

FIGS. 7 and 8 show an embodiment configured such that the linkage is in a first position with respect to a pivot point and FIGS. 9 and 10 show an embodiment configured such that the linkage is in a second position with respect to the pivot point. The linkage system 702 can include any suitable number of bars or other mechanical linkages. In the illustrated embodiment, the linkage system 702 includes four bars 708a-d. A first bar 708a is connected to a pivot point 710 affixed to the housing 604 and the first bar 708a is configured to rotate about the pivot point 710. The first bar 708a is connected to the pivot point 710 at a first end and to a second bar 708b at a first linkage 712. The second bar 708b is configured to rotate with respect to the first linkage 712.

A third bar 708c connects the second bar 708b to the piston 704 such that movement of the second bar 708b drives movement of the piston 704. The second bar 708b and the third bar 708c are connected together in any suitable manner. In the illustrated embodiment, the third bar 708c is connected to the second bar 708b at a second linkage 714.

A fourth bar 708d connects the motor 706 to the second bar 708b causing rotation of the second bar 708b about the first linkage 712 in response to movement of the motor 706. More particularly, in the illustrated embodiment the fourth bar 706d is connected to a rotatable shaft 716 of the motor 706 at a third linkage 718 positioned to travel in a circle as the rotatable shaft 716 rotates. The movement of the third linkage 718 causes the second bar 708b to pivot about the first linkage 712, via the fourth bar 708d. The pivoting of the second bar 708b causes the third bar 708c to move driving the piston 704 along the travel path.

Similar to the embodiment described above with respect to FIGS. 4 and 5, amplitude adjustment system 700 is configured for user selectable settings to define different travel paths for the piston 704. A first setting is illustrated in FIGS. 7 and 8, while a second setting is illustrated in FIGS. 9 and 10.

Turning to the embodiment illustrated in FIGS. 7 and 8, the first linkage 712 is at a first position 720 relative to the pivot point 710. In FIG. 7, the third linkage 718 connecting the motor 706 to the second bar 708b, via the fourth bar 708d, is at a location that pulls the piston 704 to a first end of a linear travel path. Specifically, the position of the third linkage 718 pulls the second bar 708b toward the motor 706 which pulls the third bar 708c and the connected piston 706 toward the motor 706.

In FIG. 8, the third linkage 718 is at a second location that pushes the piston 704 an opposing second end of the linear travel path. More particularly, the position of the third linkage 718 causes in the fourth bar 708d to pivot the second bar 708b about the first linkage 712 and press the piston 704 (via the third bar 708c) to the second end of the linear travel path.

Turning now to embodiment illustrated in FIGS. 9 and 10, the first linkage 712 is at a second position 900 relative to the pivot point 710 that is different from the first position 720. Similar to FIG. 7, the third linkage 718 is positioned by the rotatable shift 716 that pulls the piston 704 to a first end of a second linear path. Similarly, like FIG. 8, FIG. 10 illustrates a position of the third linkage 718 that presses the piston 704 to the opposing second end of the second travel path. In contrast to the travel in FIGS. 7 and 8, the travel path of FIGS. 9 and 10 is shorter and, thus, the piston 704 travels a shorter distance.

As previously noted above, the amplitude adjustment system 106 includes user-selectable settings permitting a user of the percussive massage device 100 to select a distance the piston 104 travels. The percussive massage device 100 can further include one or more structures that permit the user to adjust the amplitude adjustment system 106 to select the distance of the travel path. Any suitable structure(s) may be employed and may depend on the type of amplitude adjustment system 106 used.

For instance, the percussive massage device 600 includes the trigger 608 as an interface to control the amplitude adjustment system 700. As can be seen more clearly in FIGS. 7-10, the trigger 608 may be part of the first bar 708a. Movement of the trigger 608 causes the first bar 708a to pivot about the pivot point 710. In one embodiment, the trigger 608 is an extension of the first bar 708a that extends outside the housing 604. As shown, the trigger 608 is adjacent the handle 606. In another embodiment, the trigger 608 can be formed separately from the first bar 708a and then attached thereto.

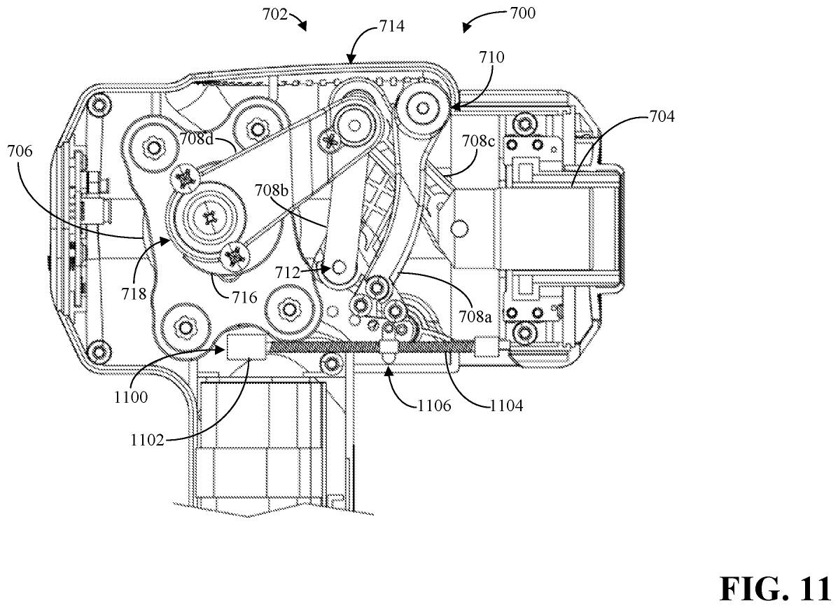

In another example, illustrated in FIG. 11, in lieu of the external trigger 608, the amplitude adjustment system 700 includes a motor driven adjustment 1100 within the housing 604 that pivots the first bar 708a about the pivot point 710. The motor driven adjustment 1100 can include a motor 1102 and a threaded arm 1104 rotatably connected to the motor. As the threaded arm rotates, a connector 1106 attached to the first bar 708a travels along the threaded arm to pivot the first bar 708a. A user can electronically select a user-selectable setting and the motor 1102 moves the first bar 708a via the threaded arm 1104 accordingly.

As briefly mentioned above, the percussive massage device 100 includes a speed control system 108 that controls a movement of the motor 102. For instance, the speed control system 108 can control the rotation speed (e.g., rotations per minute (rpm)) of the rotatable shaft of the motor 102. Because the speed of the piston 104 along the travel path is a function of speed of the motor 102, the speed control system 108 additionally controls the speed of the piston 104. In one embodiment, the user selects the speed of the motor, and the speed control system simply adjusts the motor speed according to user input, e.g., speed 1, speed 2, speed 3, etc. In one embodiment, the speed control system 108 may be capable of allowing the user to select frequency, e.g., a beats per minute (bpm) of how often the piston 104 reaches the travel path end, independent of piston 104 travel path length, which is based on the rpm of the motor as an alternative to selecting motor speed.

The speed control system 108 may be further configured to adjust speed of the motor 102 in order to maintain a selected frequency regardless of a selected amplitude. A first speed for a first travel path size results in a first bpm for the piston 104, while the first speed for a different second travel path size would result in a second bpm for the piston 104. Accordingly, in order to maintain a selected bpm, the speed control system 108 may receive information regarding the selected bpm and a selected amplitude and use that information to select a speed of the motor 102. The speed control system 108 can then change the speed of the motor 102 to maintain the selected bpm when a different amplitude is selected. The speed control system 108 may include and/or be part of a printed circuit board that is in communication with the motor 102, the power source for the motor 102 (e.g., battery 300), and/or the structure for selecting the bpm of the piston 104.

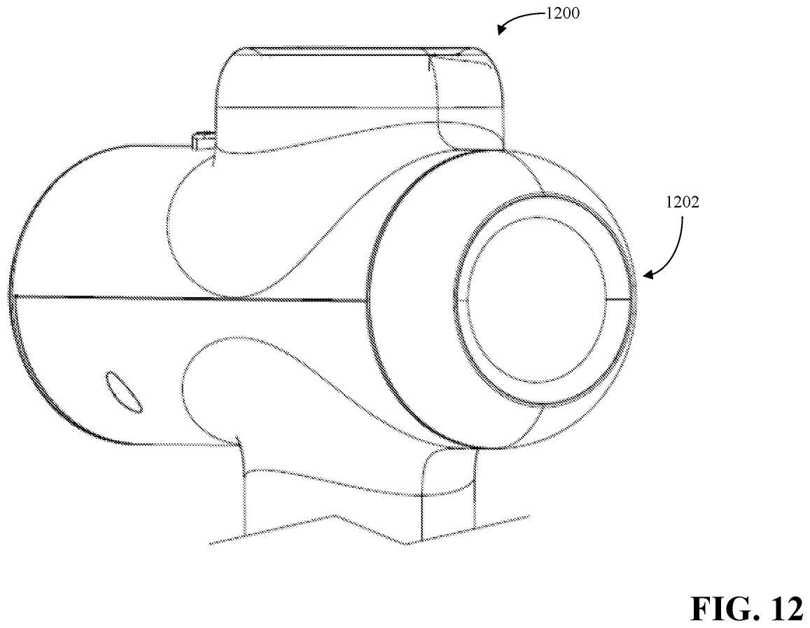

In an embodiment, illustrated in FIG. 12, a percussive massage device 1200 includes a structure 1202 on a surface that permits a user to electronically interact with a speed control system and/or an amplitude adjustment system. The structure 1202 can include one or more interfaces permitting a user to electronically select a setting for the speed control system and/or a setting the amplitude adjustment system. For instance, the structure can comprise a touch screen with different sections that can function as interfaces for adjusting the percussive massage device. In another example, the structure can include a screen with a plurality of buttons and the interface comprises one or more of the buttons.

The percussive massage device may further include an indicator(s) of a selected motor speed, frequency and/or amplitude setting. For instance, the structure for controlling the amplitude adjustment system and/or the speed control system may further include a display. For example, the structure can include a light emitting diode (LED) display that displays a selected setting. In another example, the structure can include one or more individual lights that can indicate via illumination and/or color a selected setting.

All of the percussive massage devices described herein may be further configured to receive and retain an applicator to enable a user to apply the percussive massage. As noted above, the applicator can be removably retained by the percussive massage device allowing a user to attach a variety of different applicators to apply different types of percussive massage. In an example, the piston 104 can include an indentation configured to hold the applicator while applying the percussive massage.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

We claim:

1. A percussive massage device comprising:
a motor including a rotatable shaft;
a piston configured to reciprocate rotation of the rotatable shaft, wherein velocity of the piston is a function of a rotation speed of the rotatable shaft;
an amplitude adjustment system having user-selectable settings, wherein the amplitude adjustment system controls a distance the piston travels; and
a speed control system configured to control the rotation speed of the rotatable shaft.

2. The percussive massage device of claim 1, wherein the amplitude adjustment system comprises a ratchet and pin system including:
a pin that revolves about a revolution axis;
a ratchet attached to the pin; and
at least one pawl, wherein a radial distance of the pin from the revolution axis is defined by the interaction of the ratchet and the at least one pawl, wherein the radial distance of the pin from the revolution axis controls the distance the pin travels.

3. The percussive massage device of claim 2, wherein the amplitude adjustment system further comprises an adjustment system configured to engage and disengage the pawl and the ratchet.

4. The percussive massage device of claim 3, wherein the adjustment system includes a spring configured to press the pawl into engagement with the ratchet.

5. The percussive massage device of claim 2, wherein the ratchet includes at least four notches formed thereon, wherein each notch is shaped to receive and retain a portion of the pawl for at least four different distances radial distances.

6. The percussive massage device of claim 2, further comprising:
a housing configured to retain a portion of at least one of the motor, the piston, or the amplitude adjustment system;
a handle configured for use by the user to hold the percussive massage device; and
an interface to control the amplitude adjustment system, wherein the user interface is located on a side of the housing generally adjacent to the amplitude adjustment system.

7. The percussive massage device of claim 1, wherein the amplitude adjustment system comprises a linkage system including a plurality of interlinked bars, wherein the linkage system includes at least one fixed pivot point in the percussive massage device and at least one linkage movable with respect to the fixed pivot point, wherein the position of the at least one linkage with respect to the pivot point controls the distance the piston travels.

8. The percussive massage device of claim 7, wherein the linkage system includes:
a first bar connected to the pivot point, wherein the first bar is configured to rotate about the pivot point;
a second bar connected to the first bar at a first linkage, wherein the second bar is configured to rotate about the first linkage;
a third bar connecting the second bar to the piston;
a fourth bar connecting the second bar to the motor, such that rotation of the rotatable shaft causes movement of the fourth bar causing rotation of the second bar about the first linkage, wherein the rotation of the second bar causes movement of the third bar driving movement of the piston.

9. The percussive massage device of claim 8, further comprising a housing, wherein a portion of the amplitude adjustment system is retained within the housing,
wherein a portion of the first bar extends outside of the housing, wherein movement of the portion of the first bar extending outside of the housing causes movement of the first linkage with respect to the pivot point.

10. The percussive massage device of claim 9, wherein a portion of the first bar that extends outside of the housing adjacent the handle.

11. The percussive massage device of claim 8, further comprising:
a housing configured to retain a portion of at least one of the motor, the piston, or the amplitude adjustment system;
a handle configured for use by the user to hold the percussive massage device; and
an interface to control the amplitude adjustment system, wherein the user interface is located on a bottom of the housing generally adjacent to the handle.

12. The percussive massage device of claim 1, wherein the speed control system is further configured to adjust a rotation speed of the rotatable shaft based on the distance the piston travels established by the amplitude adjustment system to maintain a selected frequency of the piston.

13. The percussive massage device of claim 1, further comprising:
a first interface to select a frequency of the piston; and
a second interface to select the distance the piston travels.

14. The percussive massage device of claim 1, wherein the amplitude adjustment system is configured to electronically select from the user-selectable settings.

15. The percussive massage device of claim 1, wherein an end of the piston is configured to receive and removably retain an applicator.

16. An amplitude adjustment system comprising:
a first portion in communication with a motor, wherein the motor includes a rotation shaft; and
a second portion in communication with a piston of a percussive massage device, wherein the piston is configured to reciprocate rotation of the rotatable shaft, wherein velocity of the piston is a function of a rotation speed of the rotatable shaft;
wherein the amplitude adjustment system has user-selectable settings that control a distance the piston travels.

17. The amplitude adjustment system of claim 16, wherein the amplitude adjustment system comprises a ratchet and pin system including:
a pin that revolves about a revolution axis;
a ratchet attached to the pin; and
at least one pawl, wherein a radial distance of the pin from the revolution axis is defined by the interaction of the ratchet and the at least one pawl, wherein the radial distance of the pin from the revolution axis controls the distance the pin travels.

18. The percussive massage device of claim 17, wherein the ratchet includes at least four notches formed thereon, wherein each notch is shaped to receive and retain a portion of the pawl for at least four different distances radial distances.

19. The amplitude adjustment system of claim 16, wherein the amplitude adjustment system comprises a linkage system including a plurality of interlinked bars, wherein the linkage system includes at least one fixed pivot point in the percussive massage device and at least one linkage movable with respect to the fixed pivot point, wherein the position of the at least one linkage with respect to the pivot point controls the distance the piston travels.

20. The percussive massage device of claim 19, wherein the linkage system includes:
a first bar connected to the pivot point, wherein the first bar is configured to rotate about the pivot point;
a second bar connected to the first bar at a first linkage, wherein the second bar is configured to rotate about the first linkage;
a third bar connecting the second bar to the piston;
a fourth bar connecting the second bar to the motor, such that rotation of the rotatable shaft causes movement of the fourth bar causing rotation of the second bar about the first linkage, wherein the rotation of the second bar causes movement of the third bar driving movement of the piston.
